(19) United States
(12) Patent Application Publication
(10) Pub. No.: US 2019/0360914 A1
(43) Pub. Date: Nov. 28, 2019

(54) FULLY AUTOMATED (UNSUPERVISED) IDENTIFICATION, MATCHING, DISPLAY AND QUANTITATION OF SUBSETS (CLUSTERS) BY EXHAUSTIVE PROJECTION PURSUIT METHODS

(71) Applicants: Stephen W. Meehan, Burnaby (CA); Darya Y. Orlova, Menlo Park, CA (US); Wayne A. Moore, San Francisco, CA (US); David R. Parks, San Francisco, CA (US); Connor Meehan, Burnaby (CA); Guenther Walther, Mountain View, CA (US); Leonore A. Herzenberg, Stanford, CA (US)

(72) Inventors: Stephen W. Meehan, Burnaby (CA); Darya Y. Orlova, Menlo Park, CA (US); Wayne A. Moore, San Francisco, CA (US); David R. Parks, San Francisco, CA (US); Connor Meehan, Burnaby (CA); Guenther Walther, Mountain View, CA (US); Leonore A. Herzenberg, Stanford, CA (US)

(21) Appl. No.: 16/401,067

(22) Filed: May 1, 2019

Related U.S. Application Data
(60) Provisional application No. 62/686,364, filed on Jun. 18, 2018.
(60) Provisional application No. 62/665,390, filed on May 1, 2018.

(51) Int. Cl. G01N 15/14

(52) U.S. Cl. CPC G01N 15/1459; G01N 15/1404; G01N 2015/1488; G01N 2015/1477; G01N 2015/1402

(57) ABSTRACT

A method for defining distributions of functional subpopulations of cells in a cell population.

### RELATED APPLICATION(S)

This application is a non-provisional application which claims the benefit of priority to U.S. Provisional Patent Application No. 62/686,364 filed on Jun. 18, 2018 entitled “Fully automated (unsupervised) identification, matching, display and quantitation of subsets (clusters) by exhaustive projection pursuit methods,” which claims the benefit of priority to U.S. Provisional Patent Application No. 62/665,390 filed on May 1, 2018 entitled “Fully automated (unsupervised) identification, matching, display and quantitation of subsets (clusters) by exhaustive projection pursuit methods,” the entireties of which are incorporated herein by reference.

### FIELD OF INVENTION

The described invention relates to methods in data analysis.

### BACKGROUND

When examining one or higher dimensional data, researchers frequently aim to identify individual subsets (clusters) of objects within the dataset. With high-dimensional data (>3 dimensions), the data become progressively more sparsly distributed in space. This, in turn, progressively increases the influence of the “curse of dimensionality” and thereby makes subset identification progressively more difficult.

To address this issue, we developed a pipeline of fully-automated sequential analysis methods that together provide statistically robust cluster identification and cluster matching tools for data generated with flow/mass cytometry and/or other technologies.

The traditional approach to locating clusters (subsets) in high-dimensional (Hi-D) datasets such as those acquired by flow cytometry is to reduce their dimensionality, usually by linear and/or nonlinear one/two dimensional mapping or projection strategies. This Projection Pursuit approach has been known since 1974 to be a very efficient method of analyzing high dimensional data in a way that avoids the curse of dimensionality. (Friedman, J. H., Tukey, J. W. A Projection Pursuit algorithm for exploratory data analysis. IEEE Transactions on Computers. C-23 (9), 881-90 (1974)). Indeed, much of what is known about stem cells, blood cells and diseases such as leukemia and AIDS relies on flow cytometry data analyzed with manual Projection Pursuit methods (for example, i.e., using “manual gating” such as that offered by FlowJo and other flow data analysis packages).

However, the resolution of such subsets is by no means routine with the available manual analysis tools. Further, because such analysis methods ultimately rely on user skills to manually define subset boundaries and other properties, subset identification and quantitation is still more appropriately recognized as art rather than science.

Automating this data analysis process and making it more objective is clearly desirable. In fact, several groups have recently developed intensive computational approaches aimed at simultaneously identifying the subsets (clusters) within a given Hi-D dataset. (Saeys, Y., Gassen, S. V., Lambrecht, B. N. Computational flow cytometry: helping to make sense of high-dimensional immunology data. Nat Rev Immunol. 16(7), 449-62 (2016). doi: 10.1038/nri.2016.56).

These attempts at Hi-D clustering methods are well motivated from a biomedical and user functionality point of view. However, they are perforce highly sensitive to compromise by what statisticians refer to as “the curse of dimensionality”, a well-known statistical problem that compromises both statistical validity and computational performance of Hi-D clustering methods [Hastie, T., Tibshirani, R., Friedman, J. The elements of statistical learning. (Springer-Verlag, 2009)]. Indeed, as we have shown, the curse of dimensionality clearly militates against the use of simultaneous Hi-D clustering methods for flow/mass cytometry and other high-dimensional data. (Orlova, D. Y., Herzenberg, L. A. & Walther, G. Science not art: statistically sound methods for identifying subsets in multi-dimensional flow and mass cytometry datasets. Nat Rev Immunol. doi:10.1038/nri.2017.150). Nevertheless, biomedical and other disciplines that rest on cluster analysis of multiparameter data require a solution to this problem.

### SUMMARY OF EMBODIMENTS

The described invention provides a method for defining distributions of functional subpopulations of cells in a cell population, comprising: a) collecting all data for all measured markers that describe a cell population; b) using a computer as software stored in a storage medium, finding a best subdivision of each subset amongst all two part splits independent of the markers used to find the sample by 1) determining a midpoint of a subset of the whole cell population; 2) Splitting the cell population into part 1 and part 2 of the cell population to form a first split cell population; 3) determining a difference between a high expression level and a low expression level for a first measured marker in part 1 and part 2 of the split population; 4) selecting and assigning to a node for the first measured marker the subset of the cell population that has the greatest difference between high expression level and low expression level in part 1 and part 2 of the split population; 5) recursively and exhaustively applying steps (1) through b(4) to the whole population for each of a second measured marker through n measured markers; 6) assigning to a second through n node each subset of the cell population that has the greatest difference between a high level of expression and a low level of expression for the second marker through n marker until a pre-established cutoff point is reached; 7) using the nodes in (b) and (d), constructing a statistical tree; c) translating the statistical tree in (1) into a tree structure that traces cells of a particular phenotype manually by (i) splitting populations of measurable parameters of interest into subsets of the cell population, (ii) identifying differences between the subsets of the cell population; and (iii) creating functional subpopulations of cells according to the amount of each measurable parameter/marker on the cell so that the cells in each functional subpopulation are more like each other than other cells.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIGS. 1A, 1B, 1C. The Exhaustive Projection Pursuit underlying principle. FIG. 1A displays a simulation of two three-dimensional sets of data (Sample A and Sample B). To identify clusters in these datasets we applied Exhaustive Projection Pursuit (EPP) approach that recursively 1) projects the data in a collection of 2D linear projections, 2) characterizes every given 2D projection by a numerical index that indicates the smallest misclassification error across a decision boundary between identified clusters, 3) separates the data across the top ranked decision boundary to produce two subsets, 4) repeats on both subsets until no splits are found. Subsets that have no further splits (groups#1-4) are final clusters identified by the EPP approach. FIG. 1B displays EPP for Sample A. FIG. 1C displays EPP for Sample B.

FIGS. 2A and 2B. The “best separation” and “the best balance” Exhaustive Projection Pursuit approaches. These two EPP approaches define the 2D projection with the most useful structure according to the lowest “split density” (“best separation” EPP) or to the lowest “split-density” value adjusted for the percent frequency of events on each side of the split (“the best balance” EPP). As an example we ran the first step of both EPP approaches on Sample B presented on FIG. 1A. FIG. 2A displays Sample B “the best separation” EPP approach. FIG. 2B displays Sample B “the best balance” EPP approach.

FIGS. 3A, 3B, and 3C. The steps of the QFMatch algorithm as applied in aligning clusters identified by the EPP approach. Merge the beforehand clustered samples FIG. 3A, samples were clustered as described on FIG. 1A) and perform adaptive binning (FIG. 3B). Split samples back preserving the binning pattern (FIG. 3C). Calculate QF dissimilarity [4,7] between each possible combination of cluster pairs from Sample A and Sample B.

FIG. 4. Pairwise QF-based dissimilarity scores. We calculate the QF dissimilarity score for each possible combination of cluster pairs from FIG. 3A. Pairs with the smallest dissimilarity scores are marked in green and considered as matched. The merging candidate is marked in blue. If as a result of the merging process the initial dissimilarity score decreases then the presence of a cluster split is indicated, if not then the unmatched cluster is considered as missing.

FIG. 5. Display of the EPP clustering outcomes using MDS method. Each circle represents one subset identified by the EPP approach. The size of the circle directly correlates with the relative frequency of the subset in the sample. Subsets that match (identified using QFMatch) between Sample A and Sample B are highlighted with the same color. X and Y axes are MDS coordinates. We ran MDS on a mixture of Sample A and Sample B to display them in the same X/Y scale.

FIGS. 6A and 6B. Manual gating strategy (FIG. 6A) that leads to exhaustive gating (FIG. 6B) of Small Peritoneal Macrophages (SPM), Large Peritoneal Macrophages (LPM), Eosinophils and non exhaustive gating of T,NK,NKT, etc. We chose a previously published dataset [9] that has biologically known cell subsets identified by manual gating (FIG. 6A).

FIGS. 7A, 7B, and 7C. Small Peritoneal Macrophages (SPM) subset identified by manual gating is in good agreement with the SPM subset identified by the EPP approach. FIG. 7A displays EPP and manual gating outcomes for the dataset described in FIG. 6A. SPM population is marked in yellow, id#1938 and id#3000 are correspondently assigned to SPM identified by EPP and manual gating. FIG. 7B validates that SPM subset was exhaustively manually gated, i.e., there is no further split in any pair of dimensions (dimension pairs were ranked according to the highest number of clusters identified on each of the 2d plot; 9 out 36 are shown here). FIG. 7C shows SPM median fluorescence intensity (MFI) for each of the marker in a stanning panel. The MFI values for SPM identified by EPP and by manual gating are in a very good agreement.

FIGS. 8A, 8B, and 8C. Large Peritoneal Macrophages (LPM) subset identified by manual gating is in good agreement with the SPM subset identified by the EPP approach. FIG. 8A displays EPP and manual gating outcomes for the dataset described in FIG. 6A. LPM population is marked in pink, id#341 and id#51000 are correspondently assigned to LPM identified by EPP and manual gating. The “pathfinder” screen is accompanying LPM subset showing the distribution of fluorescence intensity for each of the marker in the staining panel. FIG. 8B validates that LPM subset was exhaustively manually gated, i.e., there is no further split in any pair of dimensions (dimension pairs were ranked according to the highest number of clusters identified on each of the 2d plot; 9 out 36 are shown here). FIG. 8C shows LPM median fluorescence intensity (MFI) for each of the marker in a stanning panel. The MFI values for LPM identified by EPP and by manual gating are in a very good agreement.

FIGS. 9A, 9B, and 9C. Eosinophils subset identified by manual gating is in good agreement with the Eosinophils subset identified by the EPP approach. FIG. 9A displays EPP and manual gating outcomes for the dataset described in FIG. 6A. Eosinophils population is marked in green, id#1657 and id#4000 are correspondently assigned to Eosinophils identified by EPP and manual gating. FIG. 9B validates that Eosinophils subset was exhaustively manually gated, i.e., there is no further split in any pair of dimensions (dimension pairs were ranked according to the highest number of clusters identified on each of the 2d plot; 9 out 36 are shown here). FIG. 9C shows Eosinophils median fluorescence intensity (MFI) for each of the marker in a stanning panel. The MFI values for Eosinophils identified by EPP and by manual gating are in a very good agreement.

FIGS. 10A, and 10B. EPP pipeline detects composite structure in the population that was not exhaustively manually gated. FIG. 10A displays EPP and manual gating outcomes for the dataset described in FIG. 6A. Subsets that represent “T,NK,NKT,c-kit⁺ Mast cells, etc.” population are marked in violet. FIG. 10B validates that “T,NK,NKT,c-kit⁺ Mast cells, etc.” subset was not exhaustively manually gated, i.e., there are further splits in several pairs of dimensions.

FIG. 11. Branching diagram for cell subsets identified in a previously published dataset. We used EPP approach to identify clusters in a previously published dataset [9] that has biologically known cell subsets identified by manual gating (gating strategy is shown on FIG. 6A; in the EPP approach we used the same markers as those used in the manual gating strategy). EPP clustering outcomes and manual gating outcomes were matched (as described in “Alignment of subsets between samples” section) in order to assign cell subsets names to EPP clusters.

### DETAILED DESCRIPTION OF EMBODIMENTS

### Definitions

The term “Cluster of Differentiation” (CD) or “CD system” describes a protocol used for the identification of cell surface molecules present on white blood cells. CD molecules can act in numerous ways, often acting as receptors or ligands; by which a signal cascade is initiated, altering the behavior of the cell. Some CD proteins do not play a role in cell signaling, but have other functions, such as cell adhesion. Generally, a proposed surface molecule is assigned a CD number once two specific monoclonal antibodies (mAb) are shown to bind to the molecule. If the molecule has not been well-characterized, or has only one mAb, the molecule usually is given the provisional indicator “w.”

The CD system nomenclature commonly used to identify cell markers thus allows cells to be defined based on what molecules are present on their surface. These markers often are used to associate cells with certain immune functions. While using one CD molecule to define populations is uncommon, combining markers has allowed for cell types with very specific definitions within the immune system. There are more than 350 CD molecules identified for humans.

CD molecules are utilized in cell sorting using various methods, including flow cytometry. Cell populations usually are defined using a “+” or a “−” symbol to indicate whether a certain cell fraction expresses or lacks a CD molecule.

The term “curse of dimensionality” as used herein describes the phenomena characterized by as more dimensions are added, processing power needed to analyze the data also increases, as does the amount of training data required to make meaningful models.

The term “cytometry” as used herein refers to a process in which physical and/or chemical characteristics of single cells, or by extension, of other biological or nonbiological particles in roughly the same size or stage, are measured. In flow cytometry, the measurements are made as the cells or particles pass through the measuring apparatus (a flow cytometer) in a fluid stream. A cell sorter, or flow sorter, is a flow cytometer that uses electrical and/or mechanical means to divert and collect cells (or other small particles) with measured characteristics that fall within a user-selected range of values.

A “detection reagent” is any molecule that generates a detectable response indicative of the presence or absence of a substance of interest. Detection reagents include any of a variety of molecules, such as antibodies, nucleic acid sequences and enzymes. To facilitate detection, a detection reagent may comprise a marker.

The term “detectable marker” encompasses both selectable markers and assay markers. The term “selectable markers” refers to a variety of gene products to which cells transformed with an expression construct can be selected or screened, including drug-resistance markers, antigenic markers useful in fluorescence-activated cell sorting, adherence markers such as receptors for adherence ligands allowing selective adherence, and the like.

The term “differential label” as used herein generally refers to a stain, dye, marker, or antibody used to characterize or contrast structures, components or proteins of a single cell or organism.

The term “dye” (also referred to as “fluorochrome” or “fluorophore”) as used herein refers to a component of a molecule which causes the molecule to be fluorescent. The component is a functional group in the molecule that absorbs energy of a specific wavelength and re-emits energy at a different (but equally specific) wavelength. The amount and wavelength of the emitted energy depend on both the dye and the chemical environment of the dye. Many dyes are known, including, but not limited to, FITC, R-phycoerythrin (PE), PE-Texas Red Tandem, PE-Cy5 Tandem, propidium iodem, EGFP, EYGP, ECF, DsRed, allophycocyanin (APC), PerCp, SYTOX Green, courmarin, Alexa Fluors (350, 430, 488, 532, 546, 555, 568, 594, 633, 647, 660, 680, 700, 750), Cy2, Cy3, Cy3.5, Cy5, Cy5.5, Cy7, Hoechst 33342, DAPI, Hoechst 33258, SYTOX Blue, chromomycin A3, mithramycin, YOYO-1, SYTOX Orange, ethidium bromide, 7-AAD, acridine orange, TOTO-1, TO-PRO-1, thiazole orange, TOTO-3, TO-PRO-3, thiazole orange, propidium iodide (PI), LDS 751, Indo-1, Fluo-3, DCFH, DHR, SNARF, Y66F, Y66H, EBFP, GFPuv, ECFP, GFP, AmCyanl, Y77W, S65A, S65C, S65L, S65T, ZsGreenl, ZsYellowl, DsRed2, DsRed monomer, AsRed2, mRFP1, HcRedl, monochlorobimane, calcein, the DyLight Fluors, cyanine, hydroxycoumarin, aminocoumarin, methoxycoumarin, Cascade Blue, Lucifer Yellow, NBD, PE-Cy5 conjugates, PE-Cy7 conjugates, APC-Cy7 conjugates, Red 613, fluorescein, FluorX, BODIDY-FL, TRITC, X¬rhodamine, Lissamine Rhodamine B, Texas Red, TruRed, and derivatives thereof.

The term “flow cytometry” as used herein describes a technique that may be used for counting and examining cells, allows simultaneous multiparametric analysis of the physical and/or chemical characteristics of each individual cell. Briefly, a beam of light (usually laser light) of a single wavelength is directed onto a hydrodynamically-focused stream of fluid. A number of detectors are aimed at the point where the stream passes through the light beam: one in line with the light beam (Forward Scatter (FSC)), several perpendicular to it (Side Scatter (SSC)), and one or more fluorescence detectors. Each suspended cell (from 0.2 μm to 150 μm) passing through the light beam scatters the light in some way, and fluorescent molecules (naturally occurring or as part of an attached label or dye) may be excited into emitting light at a longer wavelength than the light source. This combination of scattered and fluorescent light is recorded by the detectors. The FSC correlates with the cell volume; SSC depends upon the inner complexity of the cell (i.e., shape of the nucleus, type of cytoplasmic granules, etc.). The data generated by flow cytometers may be plotted as a histogram. The regions on these plots can be separated sequentially based on fluorescence intensity by creating a series of subset extractions (“gates”). Specific gating protocols have been developed for diagnostic and clinical purposes.

The term “fluorescent-activated cell sorting” (also referred to as “FACS”) as used herein refers to a method for sorting a heterogeneous mixture of biological cells into one or more containers, one cell at a time, based upon the specific light scattering and fluorescent characteristics of each cell. Briefly, the cell suspension is entrained in the center of a narrow, rapidly flowing stream of liquid and the flow is arranged such that there is a large separation between cells relative to their diameter. The stream of individual cells passes through a fluorescence detector, and an electrical charge is assigned to each cell (based on the cell's fluorescence) just as the stream is broken into individual drops (usually via vibration) such that there is a low probability of more than one cell per droplet. Each charged droplet (containing an individual cell) may be sorted, via electrostatic deflection, into separate containers.

The surfaces of all cells in the body are coated with specialized protein receptors that selectively can bind or adhere to other signaling molecules. These receptors and the molecules that bind to them are used for communicating with other cells and for carrying out proper cell functions in the body. Each cell type has a certain combination of receptors (or surface markers) on its surface that makes it distinguishable from other kinds of cells. Cells may be fluorescently labeled, i.e., a reactive derivative of a fluorophore may be covalently attached to a cell. The most commonly used labeled molecules are antibodies; their specificity towards certain surface markers on a cell surface allows for more precise detection and monitoring of particular cells. The fluorescence labels that can be used will depend upon the lamp or laser used to excite the fluorochromes and on the detectors available. For example, when a blue argon laser (448 nm) is used, fluorescent labels used may include, but are not limited to, fluorescein isothiocyanate (FITC), Alexa Fluor® 488, green fluorescent protein (GFP), carboxyfluorescein (CFSE), carboxyfluorescein diacetate succinimidyl ester (CFDA-SE), DyLight® 488 (Dyomics), phycoerythrin (PE), propidium iodide (PI), peridinin chlorophyll protein (PerCP), PerCP-Cy™ 5.5, PE-AlexaFluor 700, PE-Cy™ 5; PE-Cy™ 5.5, PE-AlexaFluor® 750 and PE-Cy™ 7; when a red diode laser (635 nm) is used, fluorescent labels used may include, but are not limited to, allophycocyanin (APC), APC-Cy™ 7, APC-eFluor® 780, AlexFluor® 700, Cy™ 5, and Draq-5; when a violet laser is used (405 nm), fluorescent labels may include, but are not limited to, Pacific Orange™, amine aqua, Pacific Blue™, 4′-6-diamidino-2-phenylindole (DAPI), AlexFluor® 405, and eFluor® 450.

The term “marker(s)” as used herein describes the development of flow-cytometry based approaches to the identification of activation markers and intracellular markers, via measurement of enzymatic and surface marker profiles, has allowed for accelerated association of surface topologies with disease states. Studies that involve the triggering of cells to respond to environmental stimuli, such as an allergen or drug action, and the activation phenotypes associated with such agitation, allow for clearer resolution of the underlying activation states and provide for more distinct classification of allergic disease outcomes. Allergy is a dynamic event, and as such, static views of basal states would be considered insufficient for determination of an activated state, therefore rendering correlations to clinical outcomes less meaningful. Fractionation of cell populations with flow cytometry is well suited to address activation markers and intracellular markers in the context of allergic diseases, because it can simultaneously discern multiple surface markers within complex cellular populations.

The term “projection pursuit” is used to describe an exploratory data analysis method to detect “interesting” low-dimensional structures in multivariate data. It also encompasses a technique used to define a project index measuring the degree of “interestingness” of a projection onto a plane.

The term “unsupervised” is used herein a type of machine learning algorithm used to draw inferences from datasets. It may also be referred to as “fully automated.”

### Methods

To develop objective, statistically valid and computationally efficient cluster identification methods, we started with the basic ideas underlying previous automated two-dimensional (2D) Exhaustive Projection Pursuit approaches [1]. Basically, in such approaches
1) Hi-D data is presented as a collection of 2D linear projections;
2) every 2D projection is then characterized by a numerical index that indicates the amount of structure that is present [4];
3) this index is then used as the basis for a heuristic search to locate the most “useful” 2D projection;
4) once the projection with the most useful structure has been found, this structure is then segmented and each portion is recursively analyzed until there is no remaining structure detectable.

In general, these Projection Pursuit methods are a big step forward towards solving the problem of Hi-D data analysis since they avoid the curse of dimensionality. However, the approaches advanced thus far have some key limitations, e.g., it is neither obvious nor trivial to specify what constitutes structures in data and how to make inferences from such identified structures. To overcome these limitations, we have developed unsupervised Exhaustive Projection Pursuit (EPP) methods that use the smallest misclassification error across a decision boundary between identified clusters (using DBM method [5]) as an index to identify the most profitable 2D projection.

To facilitate inference from recursive EPP outcomes, we introduced multidimensional cluster matching and display methods that together with the EPP provide rapid unsupervised cluster (subset) recognition, display and characterization. These EPP analysis methods, which we describe here, provide statistically robust clustering tools for flow/mass cytometry and are readily applicable to similar types of single- or multi-dimensional data generated by other technologies.

We foresee that the methods we describe here with respect to flow cytometry data will be applicable to data generated by a wide variety of commercially and academically important technologies, including for example demographic data, retail marketing data, etc.

In many different industrial, medical, biological, business, research and/or other settings, it is desirable to study large populations of individuals, where each individual has multiple measurable properties (dimensions).

For example, in the area of marketing, a segment of the population of a country or many countries may be under consideration. Each of these persons may have multiple relevant or potentially relevant attributes that may contribute to their predisposition to purchase a given product or service or to do or refrain from a certain act. In addition, there may be numerous other properties of the individuals of a given population that are not relevant to any given propensity, such as a predisposition to buy a particular product. In addition, a given predisposition to buy may be indicated by the convergence of a plurality or even a multiplicity of properties of an individual and/or the absence of other properties. In the area of science, advancements have led to an explosion of available data, which is sometimes referred to as “Big Data” and apparatus and methods to harness and use this data are needed. See, “Drowning In Data,” Chemical & Engineering News Feb. 18, 2013, Page 40.

Because the volume of data to be considered in these diverse instances is sometimes large, it remains desirable to develop systems that can automatically aid in the analysis of data pertaining to large populations of individuals or other entities, e.g., blood cells, with multiple measurable properties (dimensions).

### Automated Exhaustive Projection Pursuit (EPP)

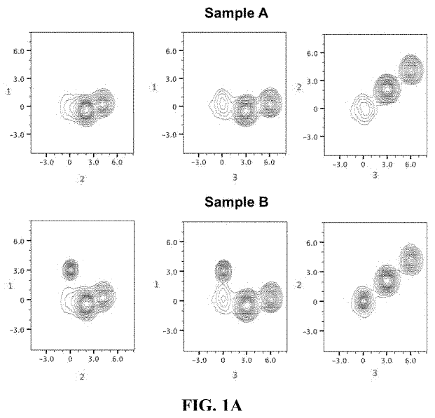

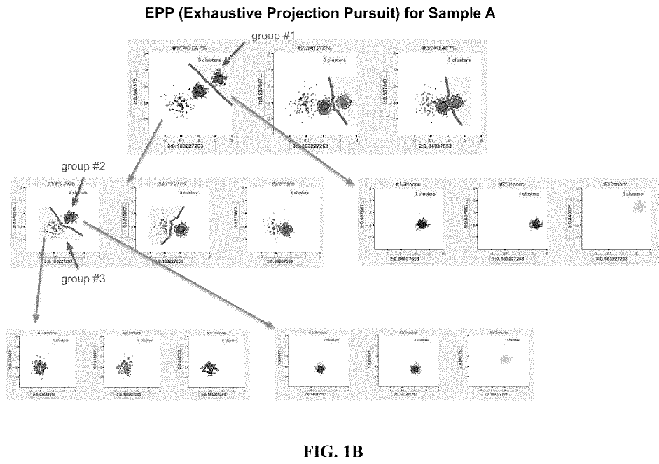

The basic strategy underlying the EPP methods is a search for an orthogonal 2D projection in which the data are cleanly split into subsets. Applied recursively, EPP carries out this strategy, identifying subsets until no further splits are available (FIGS. 1A, 1B, and 1C). For a set of measurements, EPP:
1. Examines all possible 2D projections using the density based merging (DBM) [5] clustering method
2. Finds all suitable candidate decision boundaries
3. Ranks them by estimated classifier error
4. Separates the data across the top ranked decision boundary to define two subsets
5. Repeats the above on each of the two subsets until no further splits are found

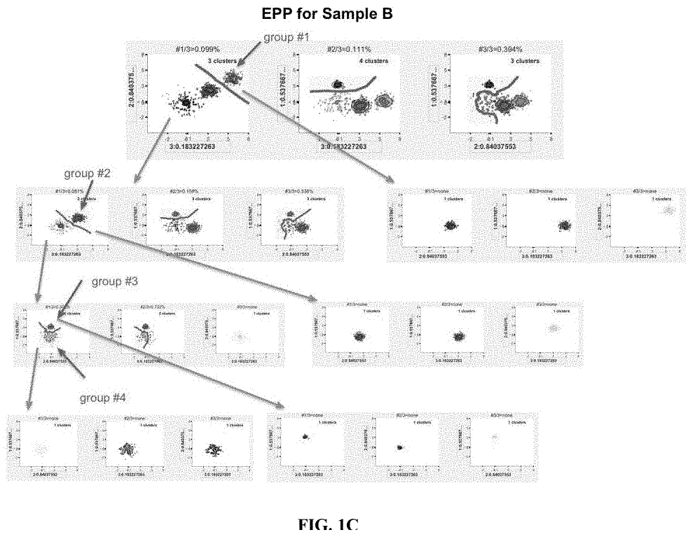

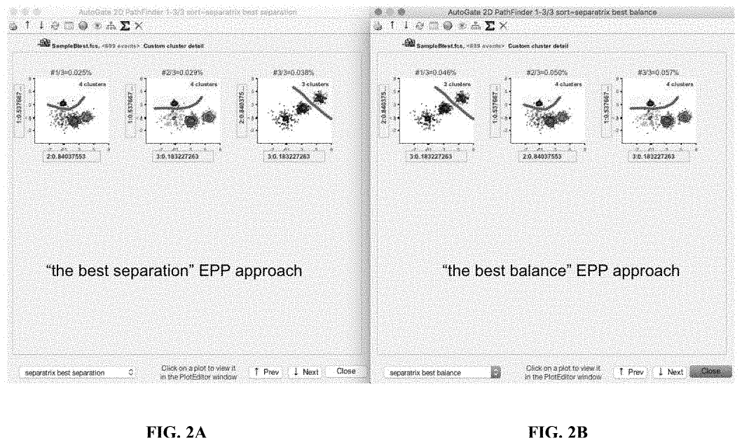

We developed two EPP criteria for choosing the best decision boundary among all possible boundaries, i.e., among all possible decision boundaries in all possible orthogonal 2D projections within the measured parameter space). We refer to these EPP criteria as “the best separation” and “the best balance” (FIGS. 2A and 2B).

### The Best Separation EPP

In this approach, the best decision boundary is the one with the lowest “split density”, which is defined as the summation of the density values at each point in a 2D density grid associated with the decision boundary. In this 2D density grid, all of the projection's data are binned (see below) according to the logic described in our previous paper and patent [5,6].

To construct this grid, we choose a positive integer M, typically M=128 or 256, and construct a grid consisting of M² points as follows:

Set Δⱼ=(maxᵢx_{i,j}−minᵢx_{i,j})/(M−1), j=1, 2,

and define the jth coordinate of y₍ₘ_{₁}_{,m}_{₂}₎ to be yₘ_{ᵢ}=minᵢx_{i,j}+(mⱼ−1)Δⱼ, mⱼ=1, . . . , M.

The grid is then defined as {y₍ₘ_{₁}_{,m}_{₂}₎:(m₁,m₂)∈{1, . . . , M}²}.

Next, each grid point yₘ,

where m=(m₁,m₂)∈{1, . . . , M²},

is assigned a weight wₘ by linearly binning the observations xᵢ, that is,

$${w}_{m} = {\sum }_{i = 1}^{n} {\prod }_{j = 1}^{2} max ( 0 , 1 - \frac{\vert {x}_{i , j} - {y}_{{m}_{j}} \vert}{{Δ}_{j}} )$$

At each grid point yₘ, m∈{1, . . . , M}², an estimate of the density surface f̊(yₘ) is computed as follows.

Denote by ϕ(x)=1/\sqrt{2π}exp(−x²/2) the Gaussian kernel. Then the estimated density at yₘ is given by

$$\hat{f} ( {y}_{m} ) = \frac{1}{n} {\sum }_{{l}_{1} = - {z}_{1}}^{{z}_{1}} {\sum }_{{l}_{2} = - {z}_{2}}^{{z}_{2}} {w}_{m - 1} \times {\prod }_{j = 1}^{2} \frac{φ ( {l}_{j} {Δ}_{j} / {h}_{j} )}{{h}_{j}}$$

$$where 1 = ( {l}_{1} , {l}_{2} ) , {z}_{j} = min ( ⌊ \frac{4 {h}_{j}}{{Δ}_{j}} ⌋ , M - 1 ) .$$

Here we establish a new definition for hⱼ:

hⱼ=h_{min,j} if n>Nₘᵢₙ

and hⱼ=h_{min,j}*(n/Nₘᵢₙ)^{(-1/6)}

otherwise, where h_{min,j}=0.023*(maxᵢxᵢⱼ−minᵢxᵢⱼ) and Nₘᵢₙ=5000.

Empirically, we have found that 0.023 is the most suitable value for most lymphocyte flow cytometry data. In the current implementation of this method (http://cytogenie.org/), we refer to this value as the “medium” level of clustering detail. We also offer several alternative implementations in AutoGate (http://cytogenie.org/): “very high”=1.5, “high”=1.6, “low”=3.2 and “very low”=4. In the current AutoGate implementation, users can reset the value of this constant and the value of Nₘᵢₙ.

### The Best Balance EPP

For this approach, the best decision boundary is the lowest “split-density” value adjusted for the percent frequency of events on each side of the split.

The formula for adjustment is (split−density)/(4*Side1frequency %*Side2frequency %).

For example, a 50/50 split would divide the split-density by 1. The decision boundary with lowest frequency-adjusted “split-density” will be defined as the best choice.

### Alignment of Subsets Between Samples

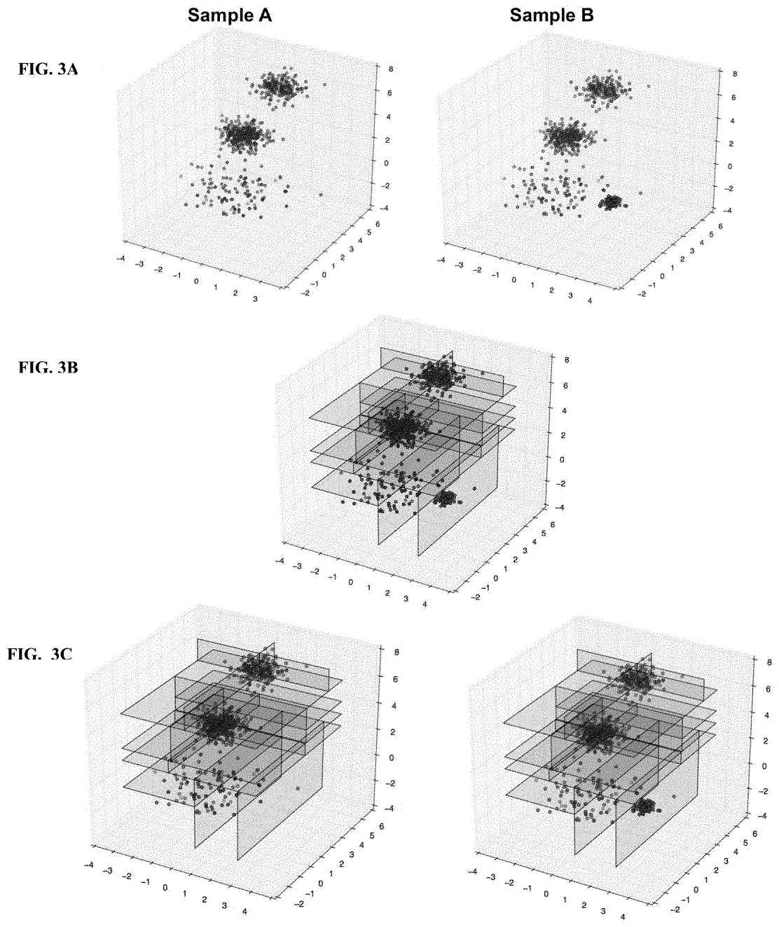

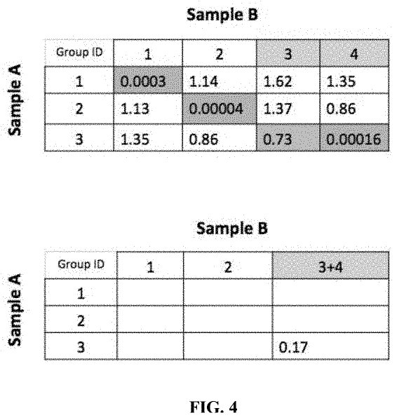

To align (match) subsets identified by EPP in two or more comparable samples (e.g., samples A and B on FIGS. 1A, 1B, and 1C), we use a quadratic form (QF)-based cluster matching algorithm (QFMatch) described in our previous paper [4,7]. FIGS. 2A, 2B, 3A, 3B and 3C illustrate the application of QFMatch to a three-dimensional dataset. Matched subsets in samples A and B are highlighted with the same color (FIG. 5).

### Visualization of EPP and Population Alignment Outcomes

To visualize all EPP clustering outcomes in a composite figure, we use a multidimensional scaling (MDS) method [8] that allows placement of each object (cluster) in two-dimensional space such that the between-object distances in high-dimensional space are well-preserved. Here, we apply this MDS method in a novel context, i.e., to the matrix of distances between median values calculated for each of the identified clusters (FIG. 5).

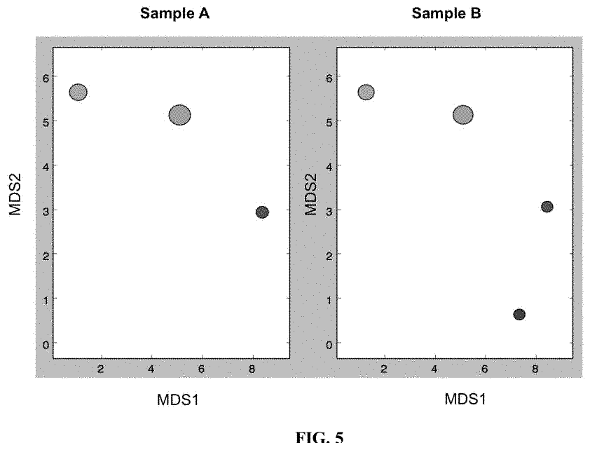

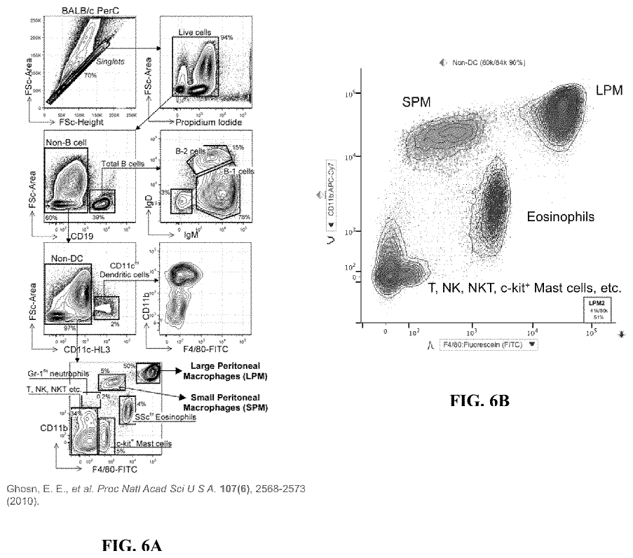

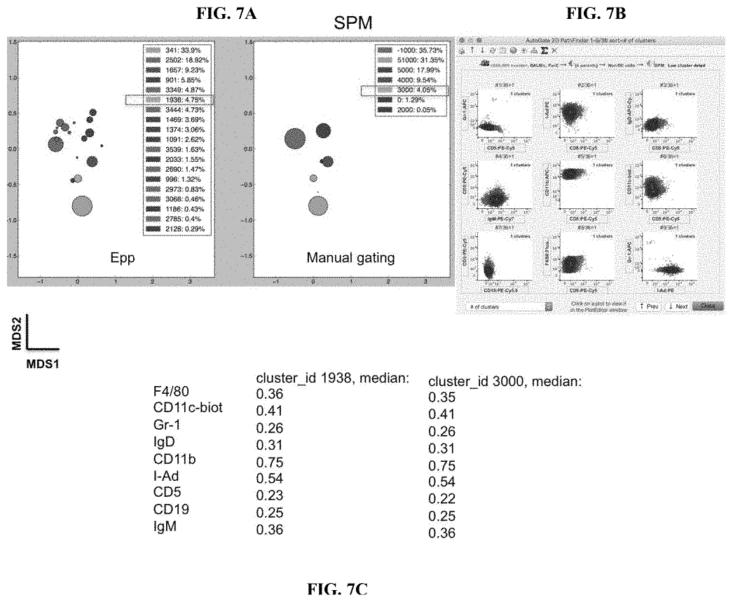

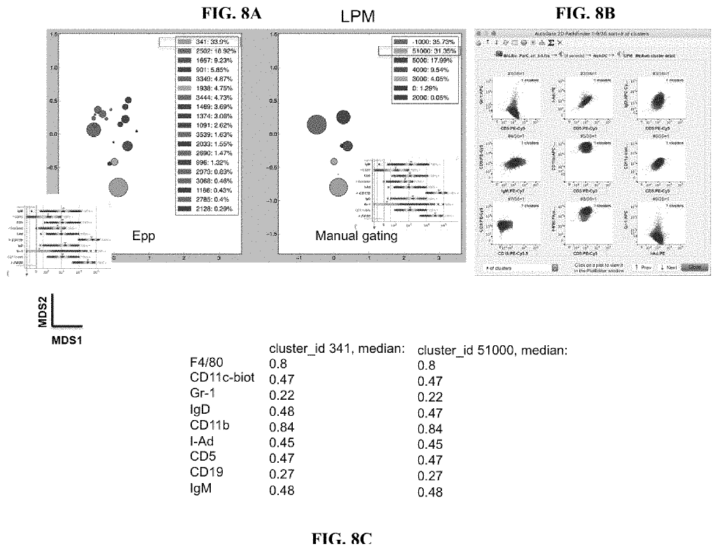

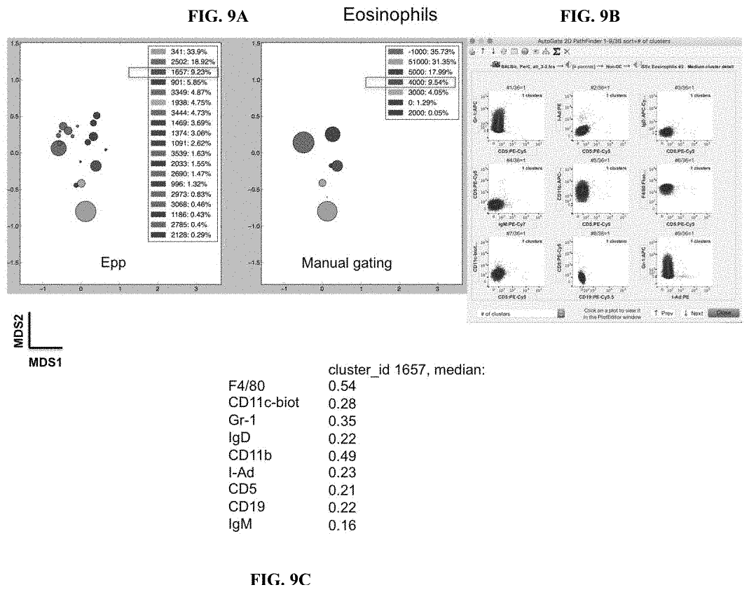

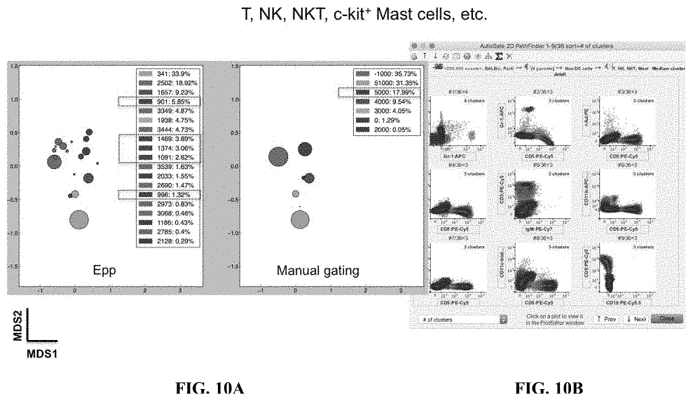

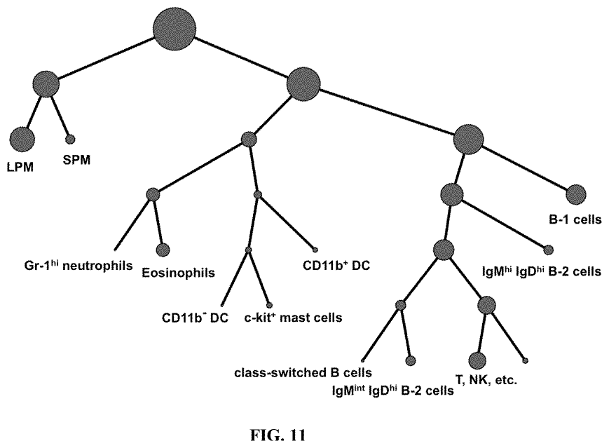

To validate the above analysis pipeline (subset identification with the EPP, high-dimensional clustermatching with QFMatch and MDS data display), we applied it to a previously published dataset [9] containing biologically known cell subsets identified by manual gating (FIGS. 6A and 6B). FIGS. 7A, 7B, 7C, 8A, 8B, 8C, 9A, 9B, 9C, 10A, and 10B show that we obtain very good agreement (median fluorescence values and cell frequencies) between cell populations identified by manual gating and by the automated pipeline described above.

To visualize EPP (or other) clustering/gating outcomes within one sample in a composite figure, we created a data display (FIG. 11) that allows agglomerative arrangement of identified clusters based on their (dis)similarity in the space of measured parameters.

This data display method builds the hierarchy from the individual clusters identified within one sample by progressively merging clusters. In order to decide which clusters should be merged a measure of dissimilarity between sets of observations is required.

We used multidimensional quadratic form (QF) score described in our previous paper [4,7] as a dissimilarity measure to combine identified clusters in a “bottom up” manner: the branching diagram starts by placing clusters with the smallest pairwise dissimilarity scores in the lowest branches of diagram; these pairs of clusters are further progressively merged in the next branching level of the diagram and further considered as one cluster; dissimilarity scores are then recalculated for all of the clusters on this branching level and the merging process is repeated. This process is sequentially repeated until all of the clusters identified within the sample are merged together.

### SOURCES

1. Friedman, J. H., Tukey, J. W. A Projection Pursuit algorithm for exploratory data analysis. IEEE Transactions on Computers. C-23 (9), 881-90 (1974).
2. Saeys, Y., Gassen, S. V., Lambrecht, B. N. Computational flow cytometry: helping to make sense of high-dimensional immunology data. Nat Rev Immunol. 16(7), 449-62 (2016). doi: 10.1038/nri.2016.56.
3. Orlova, D. Y., Herzenberg, L. A. & Walther, G. Science not art: statistically sound methods for identifying subsets in multi-dimensional flow and mass cytometry datasets. Nat Rev Immunol. doi:10.1038/nri.2017.150.
4. Orlova, D. Y., Meehan, S., Moore, W. A., Walther, G., Parks, D. R., Herzenberg, L. A. Systems and methods for cluster matching across samples and guided visualization of multidimensional cytometry data. United States patent application. U.S. Patent Application 62/363,109.
5. Walther, G., et al. Automatic clustering of flow cytometry data with density-based merging. Adv Bioinformatics. 686759; 10.1155/2009/686759 (2009).
6. Herzenberg, L. A., Moore, W. A., Parks, D. R., Walther, G., Meehan, S., Orlova, D. Y., Meehan, C. Cluster Processing and Ranking Methods Including Methods Applicable to Clusters Developed Through Density Based Merging. United States Patent Application 20150293992.
7. Orlova, D. Y., Meehan, S., Parks, D., Moore, W., Meehan, C., Zhao, Q., Ghosn, E. E., Herzenberg, L. A., Walther, G. QFMatch: multidimensional flow and mass cytometry samples alignment. Sci Rep. 8(1):3291. 2018. doi: 10.1038/s41598-018-21444-4.
8. Kruskal, J. B. and Wish, M. (1978) Multidimensional Scaling. Sage University Paper Series on Quantitative Applications in the Social Sciences, No. 07-011, Sage Publications, Newbury Park. http://dx.doi.org/10.4135/9781412985130.
9. Ghosn, E. E., et al. Two physically, functionally, and developmentally distinct peritoneal macrophage subsets. Proc Natl Acad Sci USA. 107(6), 2568-2573 (2010).

All referenced journal articles, patents, and other publications are incorporated by reference herein in their entirety.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials have been described. All publications mentioned herein are incorporated herein by reference to disclose and described the methods and/or materials in connection with which the publications are cited.

1. A method for defining distributions of functional subpopulations of cells in a cell population, comprising
a) collecting all data for all measured markers that describe a cell population;
b) using a computer as software stored in a storage medium, finding a best subdivision of each subset amongst all two part splits independent of the markers used to find the sample by
1) ‘determining a midpoint of a subset of the whole cell population;
2) Splitting the cell population into part 1 and part 2 of the cell population to form a first split cell population;
3) determining a difference between a high expression level and a low expression level for a first measured marker in part 1 and part 2 of the split population;
4) selecting and assigning to a node for the first measured marker the subset of the cell population that has the greatest difference between high expression level and low expression level in part 1 and part 2 of the split population;
5) recursively and exhaustively applying steps (1) through b(4) to the whole population for each of a second measured marker through n measured markers;
6) assigning to a second through n node each subset of the cell population that has the greatest difference between a high level of expression and a low level of expression for the second marker through n marker until a pre-established cutoff point is reached;
7) using the nodes in (b) and (d), constructing a statistical tree;
c) translating the statistical tree in (1) into a tree structure that traces cells of a particular phenotype manually by
i. splitting populations of measurable parameters of interest into subsets of the cell population,
ii. identifying differences between the subsets of the cell population; and
iii. creating functional subpopulations of cells according to the amount of each measurable parameter/marker on the cell so that the cells in each functional subpopulation are more like each other than other cells.
